(19) United States
(12) Patent Application Publication
(10) Pub. No.: US 2025/0015612 A1
(43) Pub. Date: Jan. 9, 2025

(54) LEAKAGE CURRENT PROTECTION DEVICE WITH CHARGING POWER OUTPUT

(71) Applicant: Chengli LI, Suzhou (CN)

(72) Inventors: Chengli LI, Suzhou (CN); Zenghui LV, Suzhou (CN); Xiaoming ZHANG, Suzhou (CN)

(73) Assignee: Chengli LI, Suzhou (CN)

(21) Appl. No.: 18/348,988

(22) Filed: Jul. 7, 2023

(30) Foreign Application Priority Data
Jul. 5, 2023 (CN) 202310816651.7
Jul. 5, 2023 (CN) 202321744986.4

(51) Int. Cl. H02J 7/00; H01R 13/66; H01R 13/713

(52) U.S. Cl. CPC H02J 7/00304; H01R 13/6658; H01R 13/7135; H02J 7/0042; H02J 2207/30

(57) ABSTRACT

A leakage current protection device with charging power output, including a shell and a core assembly disposed within the shell. The core assembly includes: a ground fault circuit interrupter assembly, including a first control circuit board, and a first input assembly and a first output assembly coupled to the first control circuit board; and a charging power supply assembly, including a second control circuit board, and a second input assembly and a second output assembly coupled to the second control circuit board, wherein the second control circuit board is disposed perpendicularly to the first control circuit board, and is electrically coupled to the first control circuit board by the second input assembly. While ensuring reliability of the leakage current protection function, the spatial layout of the components achieves large current power output and fast charging power output in a relatively small space.

### BACKGROUND OF THE INVENTION

This invention relates to leakage current protection devices, and in particular, it relates to a leakage current protection device having a charging power output.

With technological advancements and the increased awareness for electrical safety, electrical products having ground fault circuit interrupter (GFCI), appliance leakage current interrupter (ALCI), arc fault circuit interrupter (AFCI), etc, functions are gaining wide applications. For a leakage current protection device in the form of a power receptacle, currently available devices typically have only conventional (e.g., AC) power output sockets, but without USB (Universal serial bus) charging outlets. Such devices cannot meet the requirement of various electrical devices such as mobile phones, tablet computers, etc. which require charging under the USB power delivery protocol, such as USB Type-A or Type-C. This is inconvenient for users.

### SUMMARY OF THE INVENTION

Accordingly, there is a need for a power receptacle that has both leakage current protection (GFCI) functions and provide USB charging outlets.

To solve the above problems, embodiments of the present invention provide a power receptacle with charging power output which integrates leakage current protection function and charging power output. It has a compact size and high reliability, and provides large current power output and fast charging power output to meet different application needs.

In one aspect, the present invention provides a leakage current protection device with charging power output, which includes: a shell and a core assembly disposed within the shell, the core assembly including: a ground fault circuit interrupter assembly, including a first control circuit board, and a first input assembly and a first output assembly coupled to the first control circuit board; and a charging power supply assembly, including a second control circuit board, and a second input assembly and a second output assembly coupled to the second control circuit board, wherein the second control circuit board is disposed perpendicularly to the first control circuit board, and is electrically coupled to the first control circuit board by the second input assembly.

Based on the above principles, the invention includes any one or more of the following embodiments.

In some embodiments, the first input assembly includes at least a neutral line input terminal and a hot line input terminal, and the first output assembly includes at least a neutral line output terminal, a hot line output terminal, a neutral output conductor and a hot output conductor.

In some embodiments, the second input assembly includes conductor wires coupled to both the first control circuit board and the second control circuit board.

In some embodiments, the second output assembly includes at least one USB (Universal serial bus) power outlet.

In some embodiments, the charging power supply assembly further includes a transformer and a switch-mode power supply chip coupled to the second control circuit board.

In some embodiments, the shell includes a top cover and a base unit, wherein the first control circuit board is disposed in parallel with a bottom side of the base unit, and the second control circuit board is disposed perpendicularly to the bottom side of the base unit.

In some embodiments, the charging power supply assembly further includes a third control circuit board, dispose perpendicularly to the second control circuit board and coupled to the second control circuit board, wherein the second output assembly includes at least one USB (Universal serial bus) power outlet disposed on the third control circuit board.

In some embodiments, the ground fault circuit interrupter assembly further includes a ground fault detection ring assembly coupled to the first control circuit board.

In some embodiments, the ground fault circuit interrupter assembly further includes conductor plates configured to couple to the first input assembly and the first output assembly, wherein the conductor plates include at least a neutral conductor plate and a hot conductor plate, configured to connect or disconnect an electrical power connection between the first input assembly and the first output assembly.

In some embodiments, the leakage current protection device further includes an intermediate support frame, which defines a first installation area for installing the ground fault circuit interrupter assembly and a second installation area for installing the charging power supply assembly, and includes positioning portions for positioning the first output assembly.

In some embodiments, the leakage current protection device further includes a heat dissipater disposed in a vicinity of the charging power supply assembly.

In some embodiments, the heat dissipater is an L-shaped mounting frame, where one portion of the L shape is disposed in the vicinity of and parallel to the second control circuit board.

In some embodiments, the intermediate support frame has a mounting portion for mounting the heat dissipater, wherein the mounting portion separates the heat dissipater and the second installation area.

In some embodiments, the leakage current protection device further includes auxiliary functional components disposed on the intermediate support frame, the auxiliary functional components including a night light control assembly and/or an indicator assembly.

In some embodiments, the leakage current protection device further includes a reset assembly and a trip assembly, configured to connect or disconnect an electrical power between the first input assembly and the first output assembly.

In some embodiments, the leakage current protection device further includes a test assembly.

Embodiments of the present invention integrates charging power supply components in a leakage current protection device. While ensuring reliability of the leakage current protection function, the spatial layout of the components within the shell achieves large current power output and fast charging power output in a relatively small space. The device has a simple structure, is low cost, easy to implement, reliable, and has wide applicability.

### BRIEF DESCRIPTION OF DRAWINGS

Other features and advantages of the present invention may be understood from the embodiments described below with reference to the drawings.

FIG. 1 is a top view of a conventional power receptacle with leakage current protection function.

FIG. 2 is a top view of a power receptacle with leakage current protection function according to an embodiment of the present invention.

FIGS. 3A and 3B are perspective views of the power receptacle of FIG. 2.

FIG. 4 is an exploded view of the power receptacle of FIG. 2.

FIG. 5A illustrates the ground fault circuit interrupter assembly of the power receptacle of FIG. 2; FIG. 5B is an exploded view of the ground fault circuit interrupter assembly.

FIG. 6A illustrates the charging power supply assembly of the power receptacle of FIG. 2; FIG. 6B is an exploded view of the charging power supply assembly.

FIG. 7A illustrates the core assembly of the power receptacle of FIG. 2; FIG. 7B is a partial exploded view of the core assembly, which also shows the base unit.

FIGS. 8A to 8C are top views of power receptacles with leakage current protection function according to alternative embodiments of the present invention.

### DETAILED DESCRIPTION OF THE INVENTION

Preferred embodiments of the present and their applications are described below. It should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change.

In the descriptions below, terms such as “comprising”, “including”, “containing”, “having”, etc. are intended to be open-ended and do not exclude elements, step or components not specifically listed.

In this disclosure, unless otherwise indicated, terms such as “mount”, “connect”, “couple”, “link” etc. should be understood broadly; for example, they may be fixed connections, or removable or detachable connections, or integrally connected for integrally formed; they may be directly connected, or indirectly connected via intermediate parts, and may refer to internal connection of two components or mutual interactions of two components. Those skilled in the relevant art can readily understand the meaning of these terms as used in this disclosure based on the specific description and context.

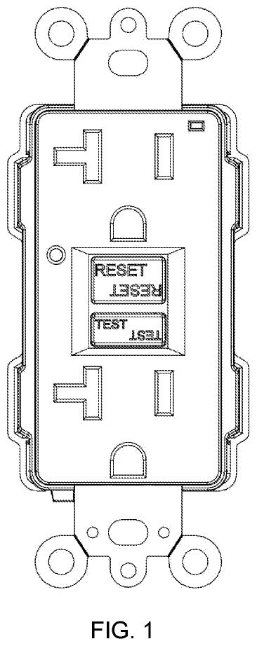

Because conventional power receptacles with only conventional (e.g., AC) power output sockets, such as that shown in FIG. 1, cannot meet users' requirements for additional charging outlets, power receptacles with USB charging outlets have been available. Key design considerations for such power receptacles include how to achieve both conventional power supply circuits and USB power supply circuits within the limited interior space of the receptacle, and how to avoid problems such as temperature rise caused by the simultaneous presence and use of these multiple different power supply circuits.

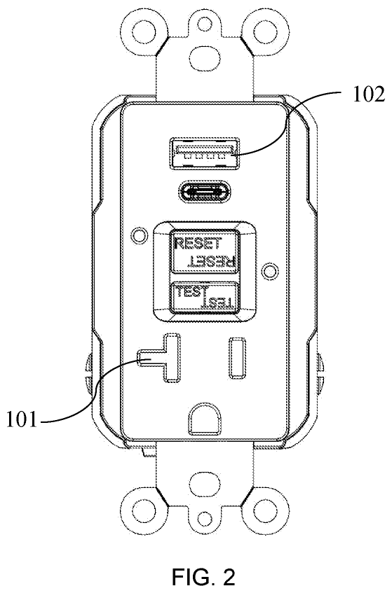

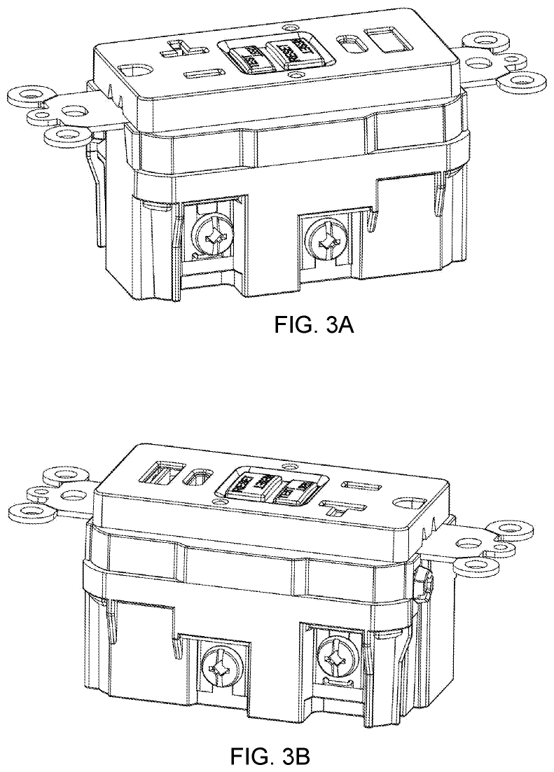

Embodiments of the present invention provide power receptacles with charging power outlet which address the above-mentioned issues. In an embodiment shown in FIGS. 2-4, the leakage current protection device includes a shell (body) and a core assembly disposed within the shell. The shell includes a top cover 1 and a base unit 18 connected to each other, such as by using fasteners such as screws, or by using hooked snaps. The base unit 18 has a relatively large capacity, to provide more space to accommodate various electrical components that accomplish large current output and fast USB charging output. The top cover 1 has multiple first output holes 101 providing a large current power output (e.g. conventional AC power output), and at least one second output hole 102 providing fast charging USB power output. The first output holes 101 may be I or T shaped depending on practical requirements; each second output hole 102 may be shaped to suit a USB Type-A or Type-C outlet.

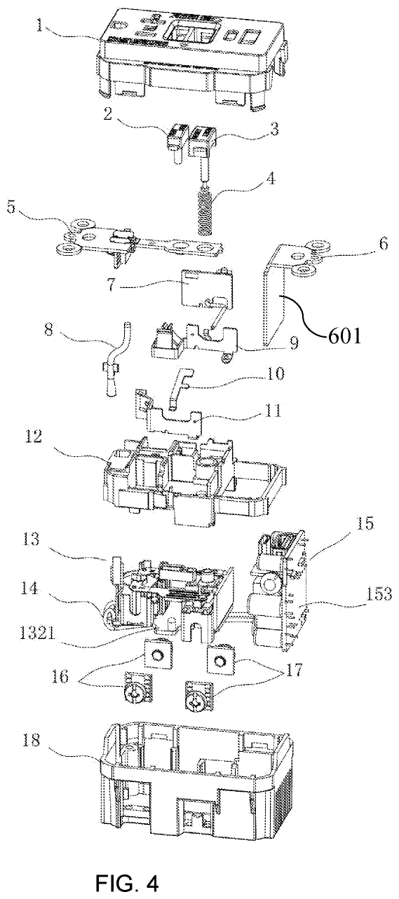

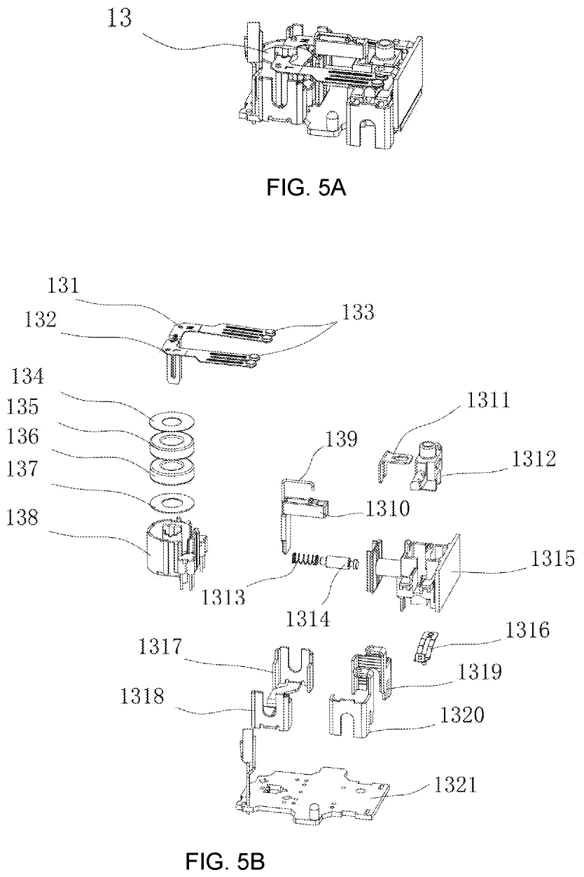

As shown in FIG. 4, the core assembly includes a ground fault circuit interrupter assembly 13 and a charging power supply assembly 15. As shown in FIGS. 5A and 5B, the ground fault circuit interrupter assembly 13 includes a first control circuit board 1321, and a first input assembly and a first output assembly coupled to the first control circuit board 1321. In the illustrated embodiment, the first input assembly includes at least a neutral line input terminal 1317 and a hot line input terminal 1318, to provide input power to the first control circuit board 1321; the first output assembly includes at least a neutral line output terminal 1319 and a hot line output terminal 1320, as well as a neutral output conductor 9 and a hot output conductor 11 (see FIG. 4). Input-end crimping blocks 16 and output-end crimping blocks 17 are respectively mounted at the input and output terminals. The neutral output conductor 9 and hot output conductor 11 form output conductors of the power receptacle (e.g. for the conventional AC power output). In some embodiments, the first output assembly further includes a grounding frame 5.

The charging power supply assembly 15 includes a second control circuit board 153, and a second input assembly and a second output assembly coupled to the second control circuit board 153. As shown in FIG. 4, the second control circuit board 153 and the first control circuit board 1321 are disposed perpendicularly to each other, and are coupled to each other by the second input assembly. In the illustrated embodiment, the second input assembly includes conductor wires 14 electrically coupled to both the first control circuit board 1321 (e.g., to the first input assembly) and the second control circuit board 153, for example, by soldering, so as to provide power to the second control circuit board 153 for the USB power outlet. The second output assembly includes at least one USB power outlet.

In the illustrated embodiment, the first control circuit board 1321 is disposed parallel to the bottom side of the base unit 18, and the second control circuit board 153 is disposed perpendicular to the bottom side of the base unit 18.

This spatial arrangement is different from the spatial arrangement used in some current power receptacles with USB charging outlet, where the two control circuit boards are disposed parallel to each other. The perpendicular arrangement according to embodiments of the present invention provides power receptacles with a more compact layout to achieve the integration of multiple types of power outlets, and addresses the temperature rise problem caused by the large amount of heat generated by the core assembly.

Preferably, the charging power supply assembly 15 further includes a transformer and a switch-mode power supply chip coupled to the second control circuit board 153, which operate to convert the AC (alternating current) power received via conductor wires 14 to DC (direct current) power in order to supply the USB charging outlet.

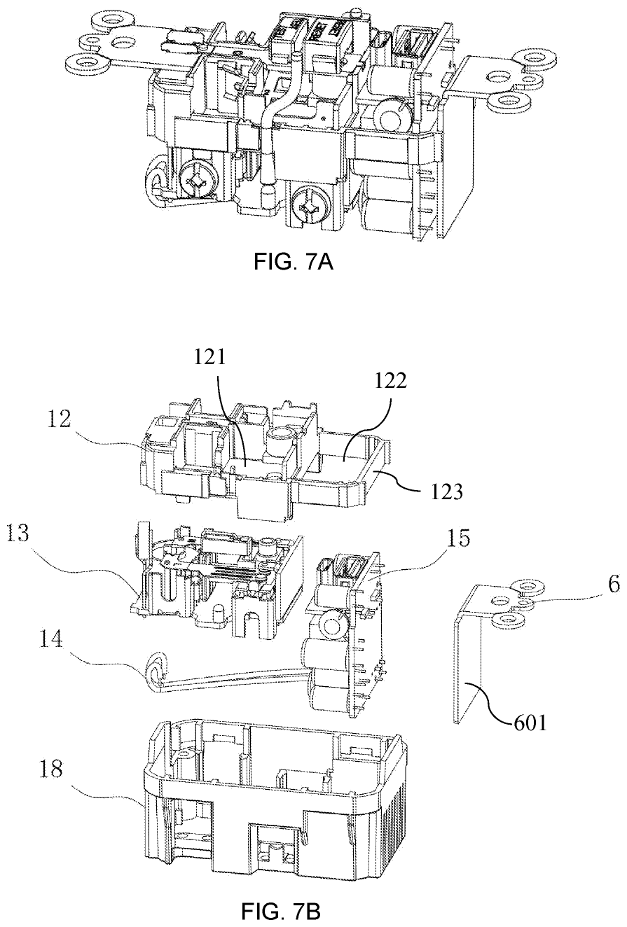

It should be understood that reduction of temperature rise may be achieved by, for example, spatially separating the ground fault circuit interrupter assembly 13 and the charging power supply assembly 15 from each other. As shown in FIGS. 4, 7A and 7B, the leakage current protection device includes an intermediate support frame 12, which defines a first installation area 121 for installing the ground fault circuit interrupter assembly 13 and a second installation area 122 for installing the charging power supply assembly 15, where the first and second installation areas are spatially separated from each other. The intermediate support frame 12 further includes positioning portions for positioning the first output assembly, more particularly, for positioning the neutral output conductor 9 and hot output conductor 11.

In some embodiments, the leakage current protection device includes at least one heat dissipater, disposed spatially near the charging power supply assembly 15, which can further reduce temperature rise. As shown in FIGS. 4, 7A and 7B, the heat dissipater 6 may be an L-shaped mounting frame, where one portion 601 of the L shape is disposed in the vicinity of and parallel to the second control circuit board 153.

In the illustrated embodiment, the intermediate support frame 12 has a mounting portion 123 for mounting the heat dissipater 6. As shown in FIG. 7B, the mounting portion 123 may have a snap or clamp structure configured to affix the portion 601 of the heat dissipater 6 to the intermediate support frame 12 at a position which is slightly separated from the second installation area 122. This way, the heat generated by the charging power supply assembly 15 during its operation can be dissipated to the exterior of the shell by the parallelly disposed heat dissipater 6, thereby lowering the interior temperature of the leakage current protection device.

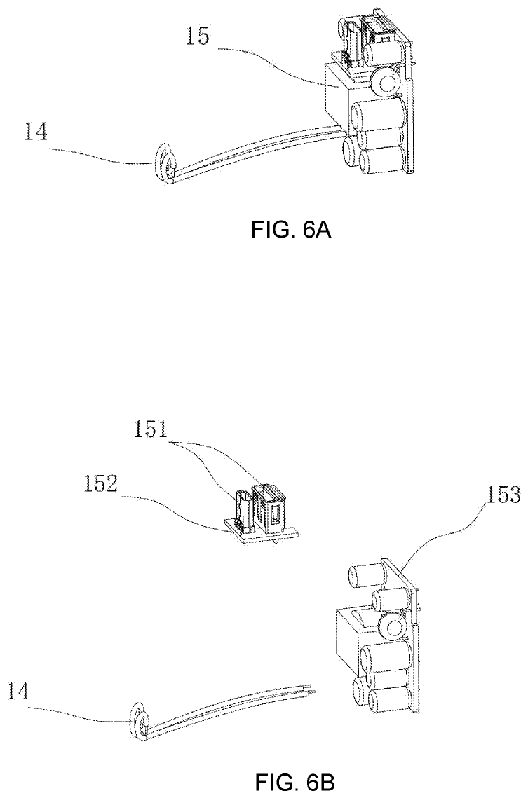

In some embodiments, the charging power supply assembly 15 further includes a third control circuit board. As shown in FIGS. 6A and 6B, the third control circuit board 152 is disposed perpendicularly to the second control circuit board 153 and coupled to the second control circuit board 153. For example, it may be soldered on to the second control circuit board 153 in a perpendicular arrangement. The second output assembly includes at least one USB power outlet 151 disposed on the third control circuit board 152. Using this structure, the third control circuit board 152 can have a small size and disposed parallel to the first control circuit board 1321, so that the USB power outlet 151 faces upwards and align with the second output hole 102 on the top cover 1.

Referring back to FIGS. 5A and 5B, the ground fault circuit interrupter assembly 13 further includes a ground fault detection ring assembly coupled to the first control circuit board 1321, and conductor plates adapted for coupling to the first input assembly and first output assembly. More specifically, two detector rings 135 and 136 are disposed between a blocking plate 134 and a shield plate 137, and disposed within a sleeve 138 to form the ground fault detection ring assembly. The conductor plates includes at least a neutral conductor plate 132 and a hot conductor plate 131, which function to connect or disconnect the electrical power connection between the first input assembly and first output assembly. The neutral and hot conductor plates 132 and 131 are formed of resilient arms, each arm having a contact terminal (moving contact terminal) 133 at the free end of the arm. The neutral and hot line output terminals 1319 and 1320 respectively have stationary contact terminals configured to form contacts with the moving contact terminals.

The leakage current protection device further includes a reset assembly and a trip assembly, which control the switching between the connected state and a disconnected state of the electrical connection between the input and output terminals of the ground fault circuit interrupter assembly 13. In some embodiments, the leakage current protection device further includes a test assembly. As shown in FIGS. 4 and 5B, the reset assembly includes a reset button 3 having a reset shaft, and a reset spring 4. The trip assembly includes a lock plate 1311, a trip lifter 1312, a trip spring 1313, a trip plunger 1314 and a coil frame 1315. The trip plunger is actuated in response to leakage current signals detected by the ground fault detection ring assembly, causing the lifter 1312 to lift the resilient arms 132 and 131. The test assembly includes a test button 2, test plate 10 and test conductor 139. Preferably, it also includes a test conductor support frame 1310. Correspondingly, the top cover 1 has two guide holes that respectively allow the reset button 3 and test button 2 to protrude out, so that they can me manually operated by a user. By operating the reset button 3, the reset assembly and trip assembly cooperate with each other to close the electrical connection between the input and output terminals (i.e., the moving contact terminals 133 of the neutral and hot conductor plates 132 and 131 contact the stationary contact terminals on the neutral and hot line output terminals 1319 and 1320). In this state, the leakage current protection device functions normally to output power. When a leakage fault occurs, or when the user manually operates the test button 2, the ground fault circuit interrupter assembly 13 detects whether the leakage current reaches a preset threshold condition. If the leakage current reaches the threshold condition, it immediately opens the electrical connection between the input and output terminals (i.e., the moving contact terminals 133 of the neutral and hot conductor plates 132 and 131 are disengaged from the stationary contact terminals on the neutral and hot line output terminals 1319 and 1320. This achieves the leakage current protection function, preventing potential electrical shock to the user. It should be understood that the trip and reset assemblies and the test assembly may be implemented by any suitable structures that can accomplish the respective functions (many such structures are currently known); the structures shown and described here are only examples and do not limit the scope of the invention.

During assembly, the trip spring 1313 and trip plunger 1314 are disposed inside the coil frame 1315 and engaged with the lock plate 1311 and trip lifter 1312. The test conductor support frame 1310 is mounted in a slot at the tail end of the coil frame 1315, so as to restrain the trip spring 1313 and trip plunger 1314 inside the coil frame 1315. An auxiliary switch plate 1316 is mounted at the bottom of the coil frame 1315 by snaps. The assembled coil frame 1315 is soldered on the first control circuit board 1321. Meanwhile, the hot and neutral conductor plates 131 and 132 pass through the assembled ground fault detection ring assembly and are soldered on the first control circuit board 1321. The test conductor 139 passes through the test conductor support frame 1310 and is soldered on the first control circuit board 1321. These components, along with the neutral line input terminal 1317, hot line input terminal 1318, neutral line output terminal 1319 and hot line output terminal 1320, which are also soldered on the first control circuit board 1321, are assembled to form the ground fault circuit interrupter assembly 13. The ground fault circuit interrupter assembly 13 functions to detect ground fault in the power output circuits, and in response to detecting a ground fault, to disconnect the electrical connection between the input terminals and the output terminals as well as the output of the power receptacle.

In some embodiments, the leakage current protection device further includes auxiliary functional components disposed on the intermediate support frame 12. In the example shown in FIG. 4, the auxiliary functional components include a night light control assembly 7 and/or an indicator assembly 8.

As an exemplary assembly process, the assembled ground fault circuit interrupter assembly 13 is electrically connected to the second control circuit board 153 of the charging power supply assembly 15 via conductor wires 14. The ground fault circuit interrupter assembly 13 and charging power supply assembly 15 are placed inside the base unit 18, keeping the first control circuit board 1321 parallel to the bottom side of the base unit. The second control circuit board 153 is kept perpendicular to the bottom side of the base unit 18. The input-end crimping blocks 16 and output-end crimping blocks 17 are respectively mounted on the neutral line input terminal 1317, hot line input terminal 1318, neutral line output terminal 1319 and hot line output terminal 1320 of the ground fault circuit interrupter assembly 13. Then, with the ground fault circuit interrupter assembly 13 and charging power supply assembly 15 having been placed inside the base unit 18, the intermediate support frame 12 is placed on the base unit. The test button 2 passes through the grounding frame 5 to abut the test plate 10 and is placed on the intermediate support frame 12. The reset button 3 and reset spring 4 also pass through the grounding frame 5 and are placed on the intermediate support frame 12. The neutral output conductor 9 and hot output conductor 11 are respectively placed in the corresponding positioning portions of the intermediate support frame 12; the hot output conductor 11 abuts the test plate 10 to ensure their electrical connection. The night light control assembly 7 and indicator assembly 8 (e.g., a light guiding plate of an indicator light) are respectively mounted on designated positions of the intermediate support frame 12. The heat dissipater 6 is mounted on the intermediate support frame 12, and is kept parallel to the second control circuit board 153 and maintained at a defined location in the base unit 18 by the intermediate support frame 12. Finally, the top cover 1 is pressed against the grounding frame 5 and the heat dissipater 6, and connected to the base unit 18 by snaps.

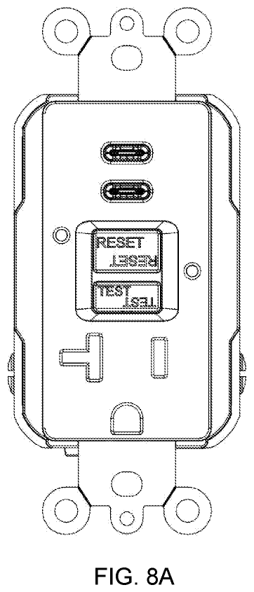

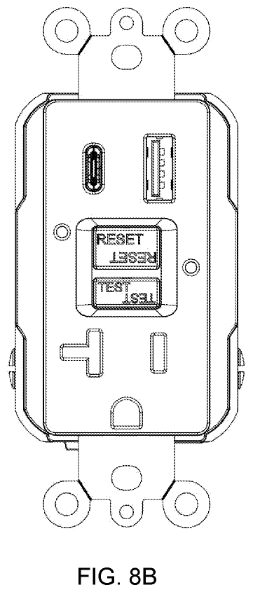

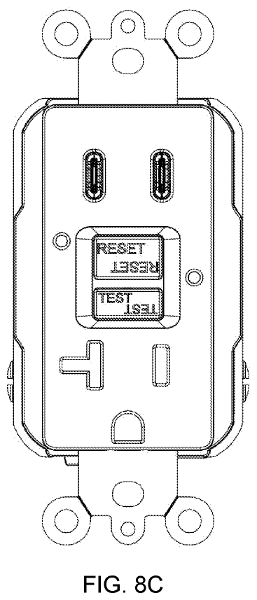

FIGS. 8A-8C show a number of power receptacles having different spatial arrangements of different combinations of types of USB charging outlets. It should be understood that other spatial arrangements and combinations of USB types are possible.

It should be understood that the embodiments shown in the drawings only illustrate the preferred shapes, sizes and spatial arrangements of the various components of the leakage current protection device. These illustrations do not limit the scope of the invention; other shapes, sizes and spatial arrangements may be used without departing from the spirit of the invention.

It will be apparent to those skilled in the art that various modification and variations can be made in the embodiments of the present invention without departing from the spirit or scope of the invention. Thus, it is intended that the present invention cover modifications and variations that come within the scope of the appended claims and their equivalents.

1. A leakage current protection device with charging power output, comprising:
a shell; and
a core assembly disposed within the shell, the core assembly including:
a ground fault circuit interrupter assembly, including a first control circuit board, and a first input assembly and a first output assembly coupled to the first control circuit board; and
a charging power supply assembly, including a second control circuit board, and a second input assembly and a second output assembly coupled to the second control circuit board,
wherein the second control circuit board is disposed perpendicularly to the first control circuit board, and is electrically coupled to the first control circuit board by the second input assembly.

2. The leakage current protection device of claim 1, wherein the first input assembly includes at least a neutral line input terminal and a hot line input terminal, and the first output assembly includes at least a neutral line output terminal, a hot line output terminal, a neutral output conductor and a hot output conductor.

3. The leakage current protection device of claim 1, wherein the second input assembly includes conductor wires coupled to both the first control circuit board and the second control circuit board.

4. The leakage current protection device of claim 1, wherein the second output assembly includes at least one USB (Universal serial bus) power outlet.

5. The leakage current protection device of claim 1, wherein the charging power supply assembly further includes a transformer and a switch-mode power supply chip coupled to the second control circuit board.

6. The leakage current protection device of claim 1, wherein the shell includes a top cover and a base unit, wherein the first control circuit board is disposed in parallel with a bottom side of the base unit, and the second control circuit board is disposed perpendicularly to the bottom side of the base unit.

7. The leakage current protection device of claim 1, wherein the charging power supply assembly further includes a third control circuit board, dispose perpendicularly to the second control circuit board and coupled to the second control circuit board, wherein the second output assembly includes at least one USB (Universal serial bus) power outlet disposed on the third control circuit board.

8. The leakage current protection device of claim 1, wherein the ground fault circuit interrupter assembly further includes a ground fault detection ring assembly coupled to the first control circuit board.

9. The leakage current protection device of claim 1, wherein the ground fault circuit interrupter assembly further includes conductor plates configured to couple to the first input assembly and the first output assembly, wherein the conductor plates include at least a neutral conductor plate and a hot conductor plate, configured to connect or disconnect an electrical power connection between the first input assembly and the first output assembly.

10. The leakage current protection device of claim 1, further comprising an intermediate support frame, which defines a first installation area for installing the ground fault circuit interrupter assembly and a second installation area for installing the charging power supply assembly, and includes positioning portions for positioning the first output assembly.

11. The leakage current protection device of claim 1, further comprising a heat dissipater disposed in a vicinity of the charging power supply assembly.

12. The leakage current protection device of claim 11, wherein the heat dissipater is an L-shaped mounting frame, where one portion of the L shape is disposed in the vicinity of and parallel to the second control circuit board.

13. The leakage current protection device of claim 11, wherein the intermediate support frame has a mounting portion for mounting the heat dissipater, wherein the mounting portion separates the heat dissipater and the second installation area.

14. The leakage current protection device of claim 10, further comprising auxiliary functional components disposed on the intermediate support frame, the auxiliary functional components including a night light control assembly and/or an indicator assembly.

15. The leakage current protection device of claim 1, further comprising a reset assembly and a trip assembly, configured to connect or disconnect an electrical power between the first input assembly and the first output assembly.

16. The leakage current protection device of claim 1, further comprising a test assembly.
